(19) United States
(12) Patent Application Publication
(10) Pub. No.: US 2011/0168156 A1
(43) Pub. Date: Jul. 14, 2011

(54) Microwave Ignition Method and Device For Cooking Appliances Using Solid Fuel

(75) Inventor: Frédéric Vandenbussche, Narseille (FR)

(73) Assignees: Philippe Clement, Marscille (FR); Frederic Vandenbussche, Marseille (FR)

(21) Appl. No.: 11/571,083

(22) PCT Filed: Jun. 29, 2005
(86) PCT No.: PCT/FR05/01653

§ 371 Date: Oct. 29, 2007

(30) Foreign Application Priority Data
Jun. 30, 2004 (FR) 0407229

(51) Int. Cl. F24B 1/26; H05B 6/64

(52) U.S. Cl. 126/25 B; 219/678

(57) ABSTRACT

The cooking appliance using solid fuel, of the barbecue type, includes a brazier as a box for containing the solid fuel, a grill support capable of supporting at least one preferably removable rack and an igniting device. The igniting device includes a very high frequency electromagnetic energy generator or magnetron capable of generating a microwave generation and a waveguide connecting the magnetron to the brazier for directing the microwaves into the brazier.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention concerns a microwave ignition method and device for cooking appliances using solid fuel, with especially advantageous applicability for barbecues using charcoal or similar solid fuel. The invention is also aimed at appliances applying this method and devices, such as barbecues or similar cooking appliances.

2. Description of Related Art Including Information Disclosed Under 37 CFR 1.97 and 37 CFR 1.98

An advantageous, although not limiting, application of the invention to cooking appliances of the barbecue type is described hereinafter.

Four types of barbecue are used today—each with advantages and disadvantages—for the cooking of food (meat, fish or else). There are solid fuel barbecues, electric barbecues, gas barbecues and lava rock barbecues (ignited with gas). Although electric barbecues and gas barbecues are more like a grill (the type of cooking is indeed different from the type of cooking with fuel barbecues), just like lava rock barbecues, they require a constant supply (for the whole duration of the cooking) of an outside (electric or gas) power. In addition, even solid fuel barbecues have a disadvantage, that is not insignificant with regard to fuel ignition. As a matter of fact, not only this step can be time-consuming and tedious, but it may also require the use of auxiliary devices not very easy to implement and/or the addition of highly flammable materials such as “fire-lighting” strips. Furthermore, the use of certain ignition methods may prove dangerous for the user or for any person close to the equipment. Documents FR-2 814 357, FR-2 813 179, U.S. Pat. No. 4,510,916, FR-2 815 532, FR-2 827 296, WO-01/67936, and EP-0 943 276, describe devices illustrating the above-mentioned disadvantages.

The purpose of the invention is thus to eliminate these disadvantages by combining cooking quality with simple, fast and efficient use of the ignition system while ensuring the safety of people and the environment.

### BRIEF SUMMARY OF THE INVENTION

According to the invention, this goal is achieved by using a method under which ignition or firing of the solid fuel placed in the pit of the appliance is carried out by subjecting the fuel to microwave radiation.

The igniting device under the invention comprises a pit or brazier consisting of a metallic box designed to contain the solid fuel and equipped with a door consisting of a perforated metal plate, the device also comprising a microwave generator connected to the box through a waveguide ending at an opening made in a wall of the box.

The invention offers several attractive advantages, such as, for example:
fast ignition with practically instantaneous incandescence of the fuel;
fool-proof efficiency as the ignition system can be operational even with high winds or when using humid fuel;
very simple ignition of the fuel that does not require the addition of any highly flammable material;
elimination of any risk of even benign burns; and
increased safety due to the presence of the door designed to cover the brazier, which at the same time is used to protect the embers against outside aggressions, such as from the wind, and preventing cinders to scatter in the vicinity of the barbecue.

### BRIEF DESCRIPTION OF THE SEVERAL VIEWS OF THE DRAWINGS

The above-mentioned goals, characteristics and advantages and else will become more apparent from the following description and the attached drawings.

FIG. 1 shows an exploded schematic view of a barbecue according to the present invention.

FIG. 2 is an exploded perspective view of the barbecue ignition device.

### DETAILED DESCRIPTION OF THE INVENTION

Reference is made to said drawings to describe the embodiment of a barbecue and of its ignition method and device under the invention.

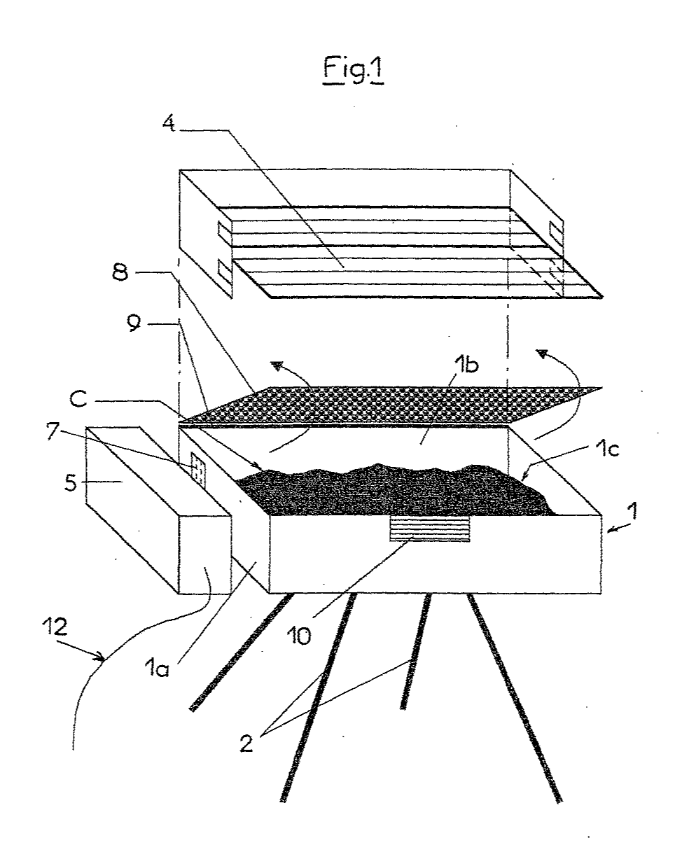

As any conventional barbecue, this barbecue comprises (FIG. 1) a brazier 1 for example consisting of a parallelepiped metallic box open in its upper part 1c and supported by legs 2 or another support. This brazier supports, preferably in a removable manner, a rack support 3 configured in a known manner to allow for positioning at an adjustable height of at least one cooking rack 4.

This assembly can be entirely or partially removable, allowing for periodic cleaning of components 1, 2, 3, 4, exposed to grease splatter and other soiling. The solid fuel C, such as charcoal or like, is placed on the bottom of the brazier 1 below the cooking rack 4.

A door 8 (referred to herein as microwave door), consisting of a stainless steel perforated plate making up a microwave barrier, covers entirely the open upper part of the brazier 1. In operating position, the door 8 lies horizontally below the cooking rack 4 at an (adjustable) distance from said rack. The door 8 can be attached to the brazier with hinges 9 placed along the upper edge of one of the sidewalls 1b of brazier 1, thus leaving rotation as the extent of freedom available to open and close this door. The closing of the microwave door 8 is secured through a closing safety device 10 that, if the door is opened, causes the microwave generator 5 described below to shut off.

For the sake of safety and to avoid any loss of energy, the microwave sealing between the microwave door 8 and the upper edge of the sidewalls of the brazier is further achieved through a seal consisting of a temperature-resistant metal braid or any other adequate device.

The cavity thus formed inside the brazier 1 can safely receive a microwave field from a microwave generator, such as a magnetron 5 operating for example on a 2450 MHz frequency. This magnetron 5 can be supplied with a source energy that can be the network current or that from a battery (as the heating time is very short), said magnetron being equipped with a conductor 12 to connect it to said energy source.

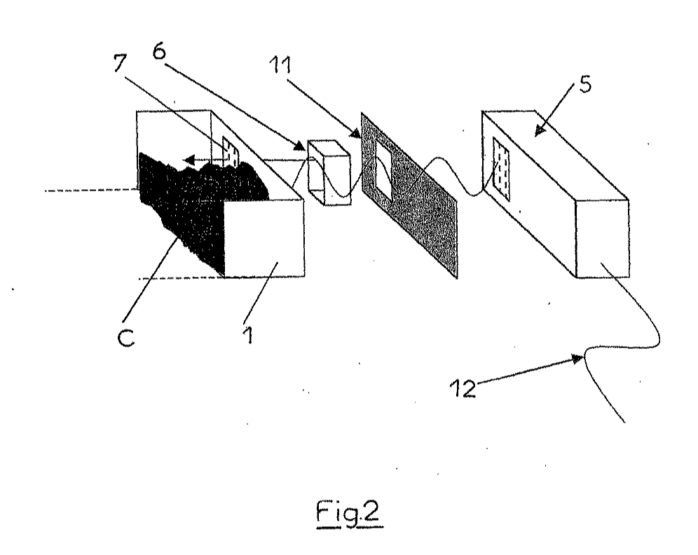

As can be seen in FIG. 2, a specific device is put in place to direct the microwaves from the magnetron outlet 5 into the brazier 1 where they propagate. The microwaves are directed by a waveguide with thermal bridge 6 so as to avoid overheating of said waveguide, the latter ending into an opening 7 made in a sidewall 1a of the brazier and equipped with a blanking device (quartz plate or grid).

Finally, in order to maintain the magnetron 5 in good working condition, a thermal insulator 11 is placed between the brazier 1 and said magnetron 5 to protect the latter against temperature rises.

After having deposited the quantity of fuel C deemed necessary on the bottom of the brazier 1 and installed the assembly consisting of the rack support 3 and cooking rack 4, the fuel ignition method under the invention consists of closing the microwave door 8 to trigger the microwave field. For safety reasons, the closing must be effective and validated by the door closing safety device 10 to thus make sure that the seal fulfills completely its function and that the brazier 1 becomes a microwave proof cavity; if not, the magnetron will not operate.

Once the microwave generation is initiated, the fuel becomes incandescent very rapidly (ignition in a few seconds) under the effect of its temperature rise resulting from the material-radiation interaction. A timer allows for the automatic shutoff of the microwave fields.

In addition, for the sake of preventing any kind of hazard, the magnetron will be stopped automatically by a timer. The microwave door 8 can then be opened to start traditional cooking or left in place.

Furthermore, since such barbecue embodiment under the invention maintains a structure close to that of a conventional fuel barbecue, odor-limiting or drippings recovery systems can be added.

1. Ignition method for cooking appliances using solid fuel, said ignition method comprising the steps of:
placing solid fuel in a brazier; and
making said solid fuel incandescent through exposure to a microwave radiation generated by an electromagnetic energy generator.

2. Ignition method according to claim 1, wherein said microwave radiation is generated from a magnetron operating on a frequency of approx. 2450 MHz.

3. Cooking appliance using solid fuel; of a barbecue type, said cooking appliance comprising:
a brazier being comprised of a box containing solid fuel;
a rack support placed above said brazier;
at least one removable rack, being supported by said rack support; and
an igniting device, being comprised of an electromagnetic energy generator or magnetron, said igniting device generating a microwave generation and a waveguide connecting said electromagnetic energy generator or magnetron to said brazier, directing microwaves into said brazier.

4. Cooking device according to claim 3, wherein said brazier has a door formed in an upper wall of said brazier, said door being comprised of a perforated metal plate.

5. Cooking device according claim 3, wherein said microwave generator or magnetron operates on a 2450 MHz frequency.

6. Cooking device according claim 4, wherein said door is attached in a pivoting manner through hinges along an upper edge of of said brazier, or wherein said door is removable from said brazier.

7. Cooking device according to claim 6, further comprising:
a microwave seal between said door and said upper edge of said brazier, said microwave seal resisting temperature generated by application of microwaves.

8. Cooking device according to claim 3, further comprising:
a thermal insulator placed between said brazier and said magnetron.

9. Cooking device according to claim 4, further comprising:
a door closing safety system, permitting instantaneous shutoff of microwave generation when said door is opened.

10. Cooking device according to claim 3, further comprising:
a timer ensuring automatic shutoff of the microwave generation after a predetermined period.
